(19) United States
(12) Patent Application Publication
(10) Pub. No.: US 2005/0185680 A1
(43) Pub. Date: Aug. 25, 2005

(54) Tunable semiconductor laser apparatus with external resonator

(75) Inventors: Takashi Tokunaga, Tokyo (JP); Yoshio Fujii, Tokyo (JP); Masahiro Tsugai, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/892,228

(22) Filed: Jul. 16, 2004

(30) Foreign Application Priority Data
Feb. 25, 2004 (JP) 2004-049038

(51) Int. Cl. H01S 3/10

(52) U.S. Cl. 372/20; 372/92

(57) ABSTRACT

A tunable semiconductor laser apparatus with an external resonator includes: a semiconductor laser device having a first end face and a second end face, the second end face being coated with an antireflection film; an optical device for collimating light emitted from the second end face; a reflecting device for reflecting the collimated light, the reflecting device and the first end face constituting an external resonator; a tunable device located between the optical device and the reflecting device; and a driving mechanism for angularly displacing the tunable device to control incidence angle of light onto the tunable device, wherein the driving mechanism includes a micro-machine actuator, thereby shortening the length of the external resonator, yet providing a wide tunable range, reducing the size of the apparatus while achieving excellent mass-productivity.

### BACKGROUND OF THE INVENTION

1. Field of the Invention

The present invention relates to a tunable semiconductor laser apparatus with an external resonator, which is suitable as a light source for optical communications and optical measurement.

2. Description of the Related Art

In an optical communication system of wavelength division multiplex, which can transmit a plurality of wavelengths using an optical fiber, a laser light source for generating light of a single oscillation wavelength at a predetermined wavelength interval is important. In case a different laser light source is individually prepared correspondingly to each of transmission wavelength, various types of light source units are needed. Therefore, a tunable laser light source which is stably tunable to a number of transmission wavelengths is demanded.

The related prior arts are listed as follows: Japanese Patent Unexamined Publications (koukai) JP-A-4-69987 (1992), JP-A-2002-353555 (2002), JP-A-9-214022 (1997) and JP-A-11-307879 (1999). The related documents are listed as follows: A) Jerman and J. D. Grade, “A mechanically-balanced DRIE rotary actuator for a high-power tunable laser,” Technical Digest of the 2002 Solid-State Sensor, Actuator, and Microsystems Workshop, Hilton Head, S.C., pp. 7-10, June 2002, and B) Lixia Zhou, Joseph M. Kahn and Kristofer S. J. Pister,“Corner-Cube-Retroreflectors-Based-on-Structure-Assisted-Assembly-for-Free-Space-Optical-Communication”, Journal of MicroElectroMechanical Systems, Vol. 12, No. 3, pp. 233-242, June 2003.

The above publication JP-A-4-69987 discloses a laser with an external resonator in which a semiconductor laser device and an reflecting mirror located outside constitute the external resonator, with a ball lens for converting laser light to parallel light and a band pass filter incorporated in between. Rotation of the band pass filter enables a resonant wavelength to be selected, resulting in a tunable oscillation wavelength of the laser. However, the document fails to describe a specific rotary drive mechanism of the band pass filter.

The above publication JP-A-2002-353555 discloses a tunable semiconductor laser with an external resonator in which a semiconductor laser device and an external reflecting mirror constitute the external resonator, with an optical band pass filter interposed inside the resonator. The optical band pass filter is located on a rotary table and the external reflecting mirror is located on a linear actuator. A controller can control the filtering characteristics by driving the rotary table to change an angle of the filter, while controlling an interval of the resonator mode by driving the actuator to change a length of the external resonator. However, since the rotary table is located inside the resonator, the total external resonator inevitably becomes large in size. Consequently, the interval of the resonator mode becomes narrow with stricter specifications of the filtering characteristics and a limited tuning range of wavelength. Therefore, it is difficult to downsize and cost-cut the laser light source.

The above publication JP-A-9-214022 discloses a tunable semiconductor laser with an external resonator, in which a rotary mechanism supporting a wavelength selection filter is located on a ceiling of housing. An angle of the filter is adjusted on manual using a flat screwdriver to perform wavelength selection.

The above document A proposes the tunable laser with a Littman-Mitcalf type of external resonator (supplied from Iolon, Inc. in the United States) instead of an optical band pass filter. Light emitted from the semiconductor laser device is collimated by the lens and reflected by a diffractive grating. Since the angle of reflection depends on wavelength, only light with a specific wavelength can be perpendicularly reflected by the opposite movable mirror to return back to the semiconductor laser device, thereby constituting the external resonator. The movable mirror is driven by a rotary actuator with MEMS (Micro Electro-Mechanical Systems). However, the length of the external resonator is also changed with the rotation of the movable mirror, resulting in mode-hopping. Therefore, the complicated mechanism is needed for driving the reflecting mirror to maintain the length of the external resonator and to effect a minute angular change.

The above publication JP-A-11-307879 discloses a tunable laser with an external resonator using the MEMS technique, in which a Fabry-Perot type of tunable filter is disposed inside the external resonator. In this tunable filter, two reflecting mirrors are supported with a gap of about 7 μm by each of an elastic supporting membranes. The gap between the mirrors is narrowed by applying voltage to each electrode on each membrane. Consequently, a transmission center wavelength of the filter can be shifted to the shorter side. However, it is very difficult to attach a wire to each electrode in the tunable filter and to align a small Fabry-Perot opening with an optical axis.

### SUMMARY OF THE INVENTION

The purpose of the present invention is to provide a tunable semiconductor laser apparatus with an external resonator, which has a short length of the external resonator with a wide tunable range, thereby downsizing the total apparatus with excellent mass-productivity.

A tunable semiconductor laser apparatus with an external resonator according to the present invention includes: a semiconductor laser device having a first end face and a second end face, the second end face being coated with an antireflection film; an optical device for collimating light emitted from the second end face; a reflecting device for reflecting the collimated light from the optical device, the reflecting device and the first end face constituting the external resonator; a tunable device arranged between the optical device and the reflecting device; and a driving mechanism for angularly displacing the tunable device to control an incident angle of light into the tunable device; wherein the driving mechanism includes a micro-machine actuator.

The driving mechanism preferably includes: a movable member for supporting the tunable device, the movable member being angularly displaced; a fixed member for defining the center of angular displacement of the movable member, the fixed member being arranged off the optical path of the external resonator; and the micro-machine actuator for angularly displacing the movable member.

The micro-machine actuator is preferably configured of a comb actuator.

In addition, the tunable semiconductor laser apparatus preferably includes: a base member for supporting the semiconductor laser device, the optical device and the reflecting device; and a tunable unit for supporting the tunable device and the driving mechanism, the tunable unit being configured separately from the base member.

Furthermore, the tunable semiconductor laser apparatus with an external resonator preferably includes a reflecting angle adjustment mechanism for adjusting the reflecting angle of the reflecting device.

The reflecting angle adjustment mechanism preferably includes: a second movable member for supporting the reflecting device; and a pair of second micro-machine actuators for individually displacing two separate locations of the movable member.

The reflecting angle adjustment mechanism preferably includes: a second movable member for supporting the reflecting device; and a second micro-machine actuator for deforming the movable member with bending elasticity.

According to the present invention, utilization of the micro-machine actuator using the MEMS technique for the driving mechanism which angularly displaces the tunable device can shorten the length of the external resonator. Therefore, the mode interval of the resonator becomes broader, so that specifications of the tunable characteristics and positioning accuracy are tolerated, thereby downsizing the total apparatus with improved mass-productivity and reduced cost.

### BRIEF DESCRIPTION OF THE DRAWINGS

FIG. 1A is a plan view showing the first embodiment according to the present invention, and FIG. 1B is a side view thereof.

FIG. 2 is a plan view showing an example wherein the fixed member 6 of the angular displacement driving mechanism is arranged on the side closer to a reflecting device.

FIG. 3A is a plan view showing an example of a structure for supporting the reflecting device, and FIG. 3B is a sectional view along the line A-A′ in FIG. 3A and FIG. 3C is a sectional view along the line B-B′ in FIG. 3A.

FIG. 4A is an explanatory view showing a technique for adjusting the yaw angle (rotary angle in the horizontal plane) of the reflecting device 4, and FIG. 4B is a explanatory view showing a technique for adjusting the position along the optical axis of the reflecting device.

FIGS. 5A and 5B are explanatory views showing a technique for adjusting the pitch angle (tilt angle) of the reflecting device, where FIG. 5A illustrates a upright state and FIG. 5B illustrates a tilting state.

FIG. 6 is a plan view showing an example of mechanism for mounting the reflecting device.

FIG. 7 is a plan view showing another example of mechanism for mounting the reflecting device.

FIG. 8 is a graph showing an example of the center wavelength of a tunable device with dependency on incident angle.

FIGS. 9A to 9C are explanatory diagrams illustrating an operation of a tunable semiconductor laser apparatus with an external resonator.

FIG. 10 is a plan view showing the second embodiment according to the present invention.

FIGS. 11A and 11B are plan views showing the third embodiment according to the present invention.

FIG. 12 is a plan view showing an example in which the center of angular displacement is arranged inside the optical path of the external resonator.

FIGS. 13A is a plan view showing the fourth embodiment according to the present invention, and FIG. 13B is a partial perspective view thereof, and FIG. 13C is a sectional view along the line C-C′ in FIG. 13B.

FIG. 14 is a side view showing the fifth embodiment according to the present invention.

### DETAILED DESCRIPTION OF THE PREFERRED EMBODIMENTS

This application is based on an application No. 2004-49038 filed on Feb. 25, 2004 in Japan, the disclosure of which is incorporated herein by reference.

Hereinafter, preferred embodiments will be described with reference to drawings.

### Embodiment 1

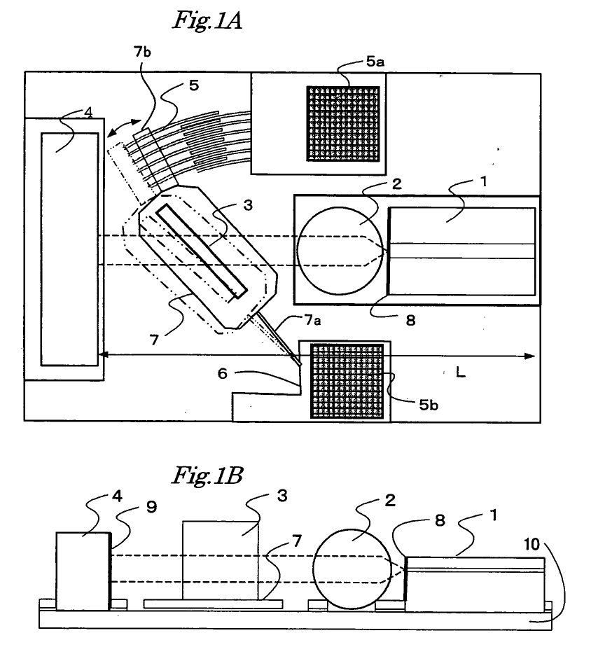

FIG. 1A is a plan view showing the first embodiment according to the present invention, and FIG. 1B is a side view thereof. A tunable semiconductor laser apparatus includes a semiconductor laser device 1, a light collecting device 2 for collecting light emitted from the semiconductor laser device 1, a reflecting device 4 for reflecting light from the light collecting device 2, a tunable device 3 having narrow band pass characteristics, and an angular displacement driving mechanism for angularly displacing the tunable device 3. These components are mounted on a base 10.

The semiconductor laser device 1 has two optical end faces, and one end face on the side of the reflecting device 4 is coated with a antireflection film 8. Another end face outside may have no coating or may be coated with a reflecting film having a predetermined reflectance. The oscillation wavelength of the semiconductor laser device 1 may be selected appropriately for applications of light source, for example, several zones of wavelength, such as 850 nm±40 nm, 1,310 nm±100 nm, and 1,550 nm±100 nm, may be selected in the field of optical fiber communications.

The light collecting device 2 serves as to collect the light emitted from the end face having the antireflection film 8 to make a parallel light. The light collecting device 2 may be configured of, e.g., a ball lens, a compound lens or a collimate lens, etc.

The reflecting device 4 constitutes the external resonator together with the outside end face of the semiconductor laser device 1 to optically feed light back to the semiconductor laser device 1. The reflecting device 4 may be configured of, e.g., a plane mirror, a prism mirror or a corner cube. The length L of the external resonator, as shown in FIG. 1A, is defined as an optical distance from a reflecting film 9 on the reflecting device 4 to the outside end face.

The tunable device 3 may be configured of, e.g., a multilayer filter in which one dielectric layer having a lower refractive index and another dielectric layer having a higher refractive index are alternately laminated on a transparent substrate, which has such characteristics as the center wavelength of the transmission band can be changed when the optical incident angle is changing. The tunable device 3 is arranged between the light collecting device 2 and the reflecting device 4, which can cause an optical reflection loss at a wavelength other than a specific wavelength defined by the incident angle to transmit only the specific wavelength.

The angular displacement driving mechanism includes a movable member 7 for supporting the tunable device 3, a fixed member 6 for defining the center of angular displacement of the movable member 7, and a micro-machine actuator 5 for angularly displacing the movable member 7.

The movable member 7 can move along a predetermined spatial plane, which herein is configured of a moving stage which can slide along the upper surface of the base 10. The movable member 7 has a beam member 7a extending toward the fixed member 6. The tip of the beam member 7a is swingably coupled to the fixed member 6. On the other hand, an action member 7b driven by the actuator 5 is attached to the movable member 7 on the side opposite to the fixed member 6.

The micro-machine actuator 5 can position the movable member 7 along a circumference around the center of angular displacement on the fixed member 6. The micro-machine actuator 5 can be defined as an actuator which is manufactured using the MEMS (Micro Electro-Mechanical Systems) technique, for example, a miniature actuator having dimensions of orders of micrometers to millimeters using magnetism, electric field, fluid, electrostriction, magnetostriction, thermal expansion or shape-memory material, etc.

In this embodiment, the micro-machine actuator 5 is configured of a comb actuator curved in the shape of circular arc. In the comb actuator, a plurality of fixed arms and a plurality of moving arms are formed concentrically in the shape of circular arc. Each of arms is alternately arranged. The moving arms can be controlled to locate at a desired position in response to a voltage applied between arms. Increasing the number of these arms facilitates the driving force of the actuator to be enhanced, resulting in the operation with higher efficiency of energy.

On both upper surfaces of a stump of the fixed arms and the fixed member 6, provided are electrodes 5a and 5b which are electrically connected to the micro-machine actuator 5, to which a control signal is supplied from an external driving circuit (not shown).

The micro-machine actuator 5 and the fixed member 6 are preferably arranged off the optical path of the external resonator in top view of the base 10. Thus the movement range of the movable member 7 with the tunable device 3 mounted can be ensured so that the reflecting device 4 can be approached as close to the semiconductor laser device 1 as possible. Consequently, the length L of the external resonator can be shortened and the mode interval of the resonator becomes broader, thereby specifications and positioning accuracy of the tunable devices 3 are tolerated.

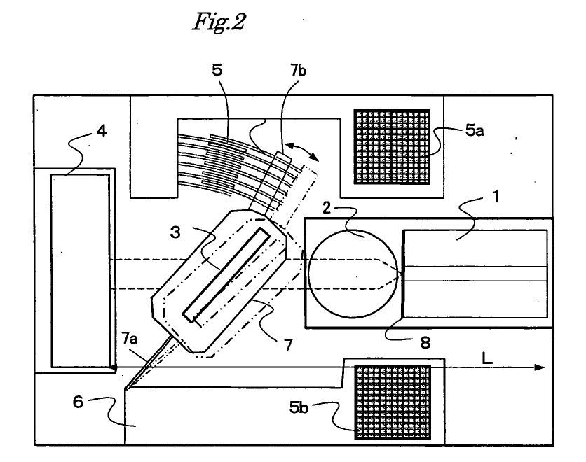

Incidentally, FIG. 1A exemplifies that the fixed member 6 is arranged on the side closer to the semiconductor laser device 1. As shown in FIG. 2, the fixed member 6 may be arranged on the side closer to the reflecting device 4, resulting in the same effect.

FIG. 3A is a plan view showing an example of a structure for supporting the reflecting device 4, and FIG. 3B is a sectional view along the line A-A′ in FIG. 3A and FIG. 3C is a sectional view along the line B-B′ in FIG. 3A. The reflecting device 4 is mounted upright on a movable member 41. The movable member 41 is supported by flexible bridge members 42 so as to move along a horizontal plane. A pair of micro-machine actuators 45 and 46 are located at a predetermined distance and attached to the movable member 41.

The micro-machine actuators 45 and 46 can be assembled using the MEMS technique, herein each configured of a comb actuator similar to the micro-machine actuator 5 as shown in FIG. 1A. In each of comb actuators, a plurality of fixed arms and a plurality of moving arms are formed linearly. Each of arms is alternately arranged. The moving arms can be controlled to locate at a desired position in response to a voltage applied between arms. Increasing the number of these arms facilitates the driving force of the actuator to be enhanced, resulting in the operation with higher efficiency of energy.

On both upper surfaces of stumps of the fixed arms, provided are electrodes 45a and 46a which are electrically connected to the micro-machine actuators 45 and 46, respectively. On an upper surface of a stump of the bridge members, provided is a common electrode 46b of the micro-machine actuators 45 and 46. Control signals are supplied from an external driving circuit (not shown) to the electrodes 45a and 46a.

Outside the micro-machine actuators 45 and 46, separately provided are a pair of micro-machine actuators 47 and 48 for controlling the tilt angle of the reflecting device 4. The micro-machine actuators 47 and 48 can be assembled using the MEMS technique, herein each configured of a piezoelectric actuator including an electrostriction material such as PZT (PbZrTiO). The piezoelectric actuator can functionally expand or contract in response to an applied voltage, as shown in FIG. 5, so as to control the reflecting device 4 at a desired tilt angle by applying a bending moment through the bridge members 42 to the movable member 41.

As shown in FIG. 1A, light emitted from the semiconductor laser device 1 passes through the light collecting device 2 and the tunable device 3 and then reflects on the reflecting device 4 to return back along the same optical path into the semiconductor laser device 1, thereby the optical resonator can be constituted. Therefore, it is important that the optical axis of the resonator is perpendicular to the reflecting face of the reflecting device 4. Since the semiconductor laser device 1 is generally manufactured and mounted in a process different from processes for the tunable device 3 and the reflecting device 4, the optical axis of the semiconductor laser device 1 may be deviated due to an alignment error in mounting. The deviation of the optical axis can be corrected by employing the supporting structure including the micro-machine actuators 45 to 48 as described above.

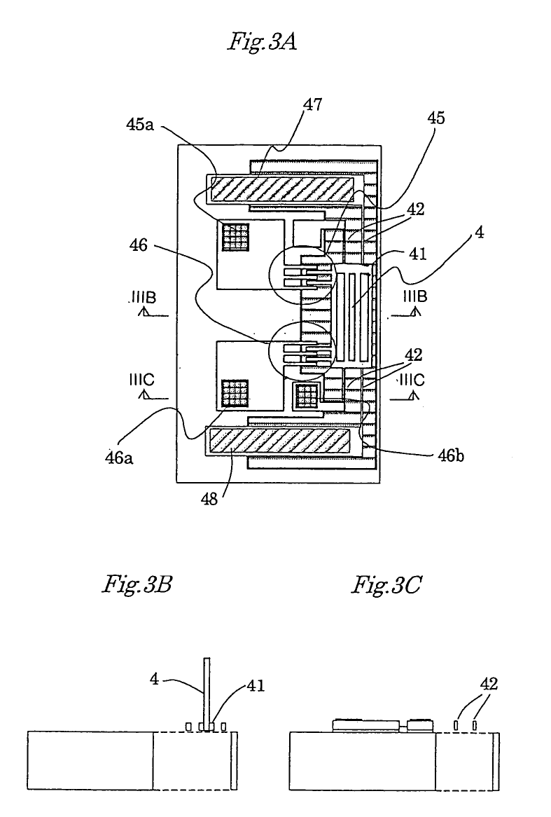

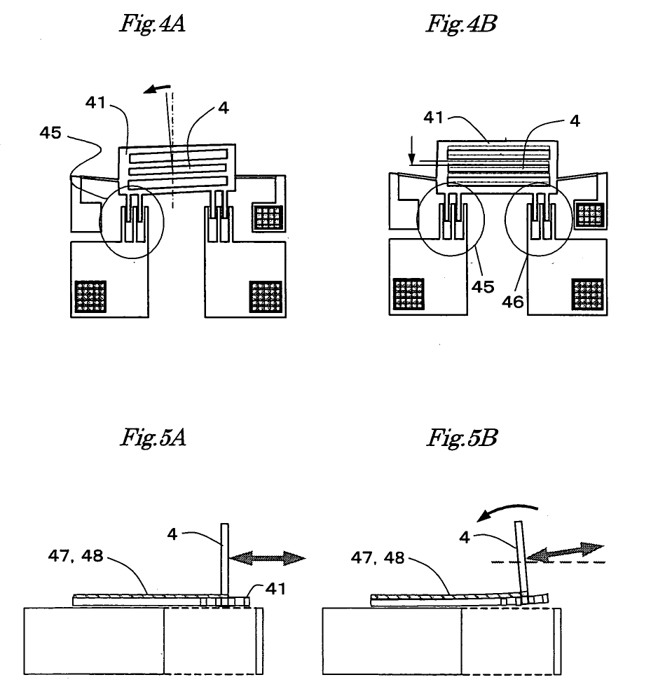

FIG. 4A is a explanatory view showing a technique for adjusting the yaw angle (rotary angle in the horizontal plane) of the reflecting device 4, and FIG. 4B is a explanatory view showing a technique for adjusting the position along the optical axis of the reflecting device 4. First, in FIG. 4A, the movable member 41 is angularly displaced in the horizontal plane by driving either of the micro-machine actuators 45 and 46, thereby the yaw angle of the reflecting device 4 can be adjusted.

Next, in FIG. 4B, the movable member 41 is linearly displaced along the optical axis by driving both of the micro-machine actuators 45 and 46 so as to keep both the displacements coincident with each other, thereby the distance between the reflecting device 4 and the semiconductor laser device 1, i.e., length L of the external resonator can be adjusted to control wavelengths and mode intervals in a longitudinal mode of the resonator.

FIGS. 5A and 5B are explanatory views showing a technique for adjusting the pitch angle (tilt angle) of the reflecting device 4, where FIG. 5A illustrates an upright state and FIG. 5B illustrates a tilting state. When the micro-machine actuators 47 and 48 are so driven to keep both the displacements coincident with each other, the same quantity of bending moment is applied to each of sides of the movable member 41. Consequently, the pitch angle of the reflecting device 4 can be adjusted by the movable member 41 being bent. In case the micro-machine actuators 47 and 48 are so driven to keep one of displacements different from the other, the pitch angle and the yaw angle of the reflecting device 4 can be simultaneously adjusted.

Using the above mechanism for adjusting the reflecting angle of the reflecting device 4 and the length L of the external resonator, attachment errors in mounting the optical components can be canceled, thereby enhancing yield of manufacturing.

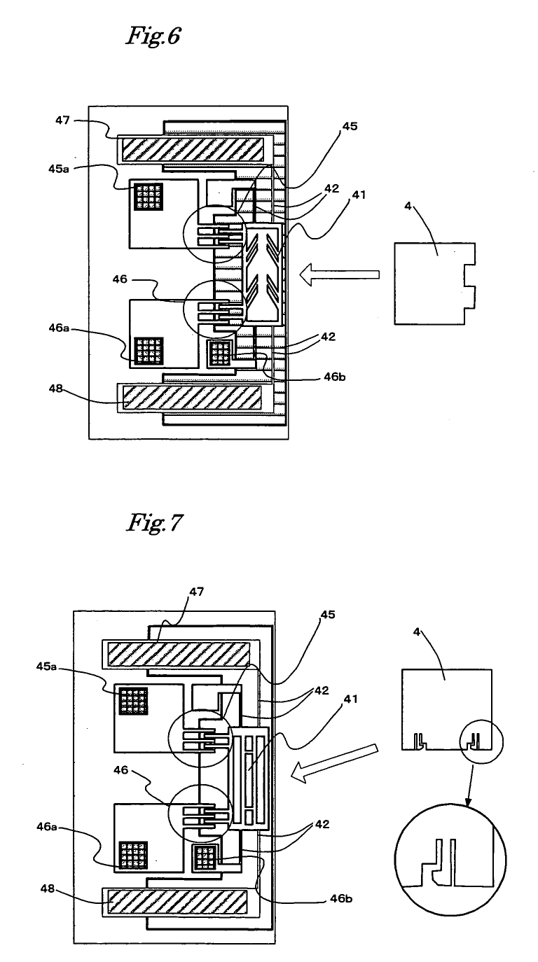

FIG. 6 is a plan view showing an example of mechanism for mounting the reflecting device 4. The reflecting device 4 is formed of a plane substrate, such as glass or Si, with a high reflective film, such as Au, Al or dielectric multilayer film, coated thereon. The movable member 41 has gap deformable portions which the reflecting device 4 can fit into. The reflecting device 4 also has a shape adaptable to openings of the gap deformable portions. The reflecting device 4 is fixed by inserting and sliding into the gap deformable portions.

FIG. 7 is a plan view showing another example of mechanism for mounting the reflecting device 4. The reflecting device 4 is formed of a plane substrate, such as glass or Si, with a high reflective film, such as Au, Al or dielectric multilayer film, coated thereon. The reflecting device 4 has gap deformable portions in the bottom, which the movable member 41 can fit into. The movable member 41 also has a shape adaptable to openings of the gap deformable portions. The reflecting device 4 is fixed by inserting and sliding into the openings.

Using not only such a insertion mounting but also adhesives or solder, the reflecting device 4 may be fixed.

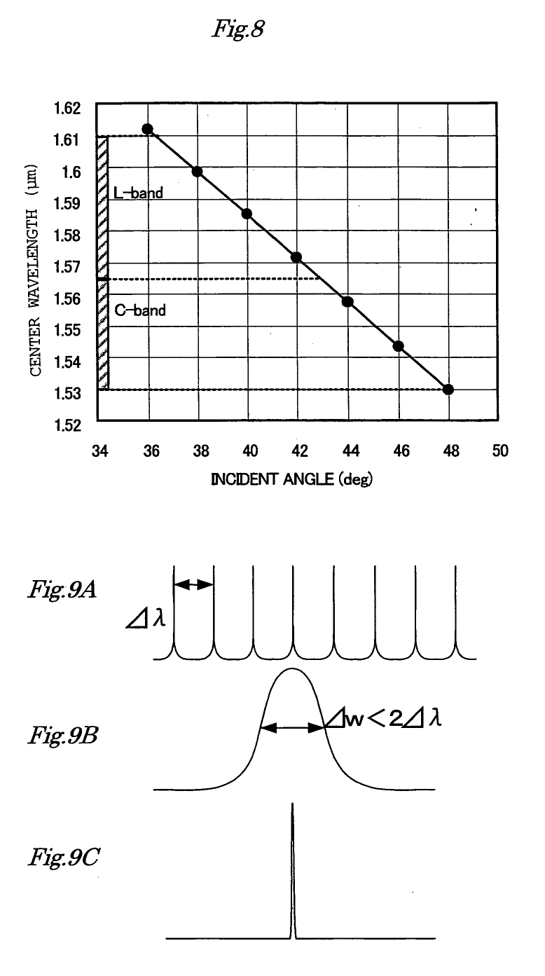

FIG. 8 is a graph showing an example of the center wavelength of the tunable device 3 with dependency on incident angle. The horizontal axis shows the incident angle θ (degree) into the tunable device 3. The vertical axis shows the center wavelength (μm) of bandpass characteristics. When the incident angle θ of light is set in a range of 43 to 48 degrees, the tunable device 3 can be tuned into C-band (1,530 to 1,565 nm) of wavelength bands in optical communications. When the incident angle θ of light is set in a range of 36 to 43 degrees, the tunable device 3 can be tuned into L-band (1,565 to 1,610 nm) of wavelength bands in optical communications.

For the tunable device 3, either one type which is formed of a transparent substrate with a dielectric multilayer film having a narrow wavelength selection characteristics coated on the one face and with an antireflection film coated on the other face, or another type which is formed of a transparent substrate with dielectric multilayer films each having a narrow wavelength selection characteristics coated on both of the faces can be used, wherein a refractive index and a thickness of each layer in the dielectric multilayer film is decided depending on specifications of design, including initial incident angle, center wavelength, tunable range, etc.

FIGS. 9A to 9C are explanatory diagrams illustrating an operation of a tunable semiconductor laser apparatus with an external resonator. The horizontal axis shows wavelength and the vertical axis shows intensity of light. The semiconductor laser device 1 has typically a relatively broad gain spectrum, as shown in FIG. 9A, in which a plurality of longitudinal modes can be oscillated at a mode interval Δε (=Δ²/2L) of resonator, which is defined by the length L of the external resonator and wavelength ε. The tunable device 3 having band pass filtering characteristics, as shown in FIG. 9B, is interposed inside the resonator, so that a longitudinal mode located near the center wavelength of the filtering characteristics becomes dominant. Therefore, the half bandwidth ΔW of the filtering characteristics of the tunable device 3 smaller than 2*Δε, i.e., ΔW<2*Δε, facilitates only a particular single longitudinal mode to oscillate selectively, as shown in FIG. 9C. Additionally, the center wavelength of the filter can be changed continuously by adjusting the incident angle into the filter.

For example, since the effective length L of the resonator is 2.5 mm in consideration of each refractive index of the semiconductor laser device 1, the light collecting device 2 and the tunable device 3, the mode interval of resonator Δε=0.48 nm is established at wavelength ε=1,550 nm. Therefore, the tunable device 3 with band pass characteristics of the half bandwidth of filter ΔW<0.96 nm is suitably used. The tunable device 3 having such characteristics can be configured of a dielectric multilayer filter. For example, lamination of nearly fifteen layers including a Si layer and a SiO₂ layer results in desired characteristics.

Since the mode of resonator is distributed discretely with an interval Δε, mode-hopping from a particular longitudinal mode to the adjacent longitudinal mode is caused when the tunable device 3 is rotating. Therefore, it is preferable that the wavelength in emission spectrum, as shown in FIG. 9A, is continuously shifted to attain continuous tunability without mode-hopping and stable light intensity. For an approach for shifting the wavelength, control by a phase adjusting region provided in the semiconductor device 1, or controlling the length L of the resonator by an actuator attached to the reflecting device 4 of the external resonator, as shown in FIG. 4B, may be employed.

Furthermore, it is preferable that components, such as the semiconductor laser device 1, the tunable device 3, the reflecting device 4, etc, are stabilized in temperature to maintain the laser oscillation with stable wavelength and light intensity. For an approach for stabilizing temperature, combination of heat dissipation by a heat sink, cooling by a Peltier device, and temperature detection by a thermistor may be employed.

### Embodiment 2

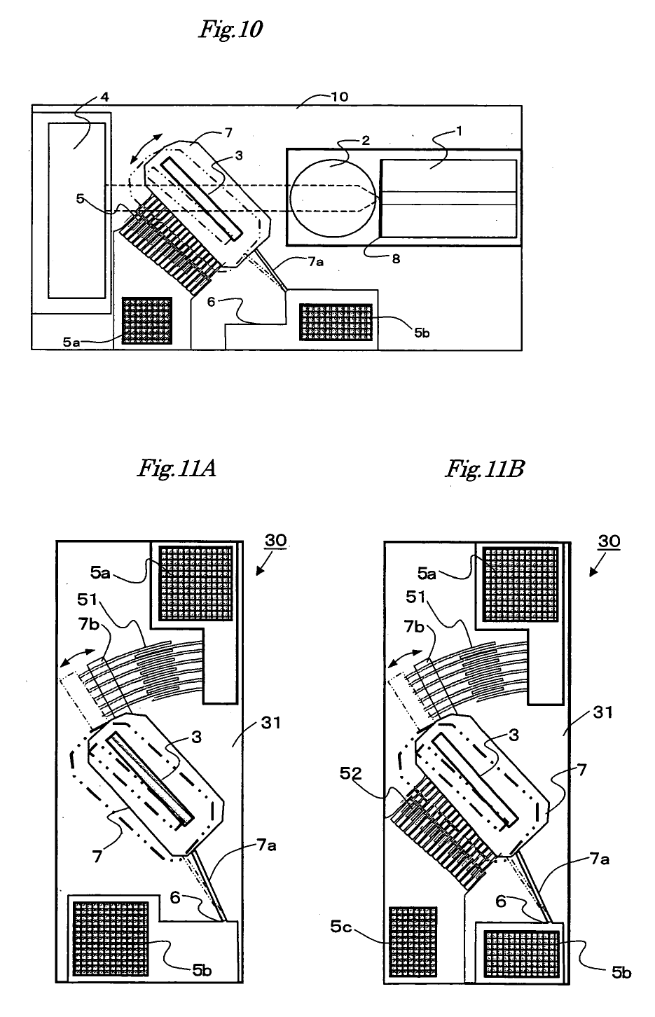

FIG. 10 is a plan view showing the second embodiment according to the present invention. A tunable semiconductor laser apparatus includes a semiconductor laser device 1, a light collecting device 2 for collecting light emitted from the semiconductor laser device 1, a reflecting device 4 for reflecting light from the light collecting device 2, a tunable device 3 having narrow band pass characteristics, and an angular displacement driving mechanism for angularly displacing the tunable device 3. These components are mounted on a base 10.

The semiconductor laser device 1, the light collecting device 2, the tunable device 3 and the reflecting device 4 are similar in configuration and operation to those of the first embodiment, hereinafter tautological description will be omitted.

In this embodiment, the micro-machine actuator 5 is mounted at a location different from that in FIG. 1 in the angular displacement driving mechanism for angularly displacing the tunable device 3, resulting in a smaller footprint of the whole apparatus.

The angular displacement driving mechanism includes a movable member 7 for supporting the tunable device 3, a fixed member 6 for defining the center of angular displacement of the movable member 7, and the micro-machine actuator 5 for angularly displacing the movable member 7.

The movable member 7 can move along a predetermined spatial plane, which herein is configured of a moving stage which can slide along the upper surface of the base 10. The movable member 7 has a beam member 7a extending toward the fixed member 6. The tip of the beam member 7a is swingably coupled to the fixed member 6.

The micro-machine actuator 5 is arranged on the side face of the movable member 7, which can position the movable member 7 along a circumference around the center of angular displacement on the fixed member 6. The micro-machine actuator 5 can be defined as an actuator which is manufactured using the MEMS (Micro Electro-Mechanical Systems) technique, for example, a miniature actuator having dimensions of orders of micrometers to millimeters using magnetism, electric field, fluid, electrostriction, magnetostriction, thermal expansion or shape-memory material, etc.

In this embodiment, the micro-machine actuator 5 is configured of a comb actuator curved in the shape of circular arc. In the comb actuator, a plurality of fixed arms and a plurality of moving arms are formed concentrically in the shape of circular arc. Each of arms is alternately arranged. The moving arms can be controlled to locate at a desired position in response to a voltage applied between arms. Increasing the number of these arms facilitates the driving force of the actuator to be enhanced, resulting in the operation with higher efficiency of energy.

On both upper surfaces of a stump of the fixed arms and the fixed member 6, provided are electrodes 5a and 5b which are electrically connected to the micro-machine actuator 5, to which a control signal is supplied from an external driving circuit (not shown).

The fixed member 6, which defines the center of angular displacement, is preferably arranged off the optical path of the external resonator in top view of the base 10. Thus the movement range of the movable member 7 with the tunable device 3 mounted can be ensured so that the reflecting device 4 can be approached as close to the semiconductor laser device 1 as possible. Consequently, the length L of the external resonator can be shortened and the mode interval of the resonator becomes broader, thereby specifications and positioning accuracy of the tunable devices 3 are tolerated.

### Embodiment 3

FIGS. 11A and 11B are plan views showing the third embodiment according to the present invention. In this embodiment, the tunable device 3 and the angular displacement driving mechanism for angularly displacing the tunable device 3 constitutes a tunable unit 30.

The semiconductor laser device 1, the light collecting device 2, the tunable device 3 and the reflecting device 4 are similar in configuration and operation to those of the first embodiment, hereinafter tautological description will be omitted.

The tunable unit 30 includes the tunable device 3 having narrow band pass characteristics, the angular displacement driving mechanism for angularly displacing the tunable device 3 constitutes a tunable unit 30, and a unit base 31 for supporting these components. The tunable unit 30 is configured separately from the base 10 as shown in FIG. 1, subsequently mounted on the base 10 at an assembly step for the tunable semiconductor laser apparatus.

First, in FIG. 11A, the movable member 7 is configured of a moving stage which can slide along the upper surface of the unit base 30. The movable member 7 has a beam member 7a extending toward the fixed member 6. The tip of the beam member 7a is swingably coupled to the fixed member 6. On the other hand, an action member 7b driven by the actuator 51 is attached to the movable member 7 on the side opposite to the fixed member 6.

On both upper surfaces of a stump of the fixed arms and the fixed member 6, provided are electrodes 5a and 5b which are electrically connected to the micro-machine actuator 51, to which a control signal is supplied from an external driving circuit (not shown).

Second, in FIG. 11B, an additive micro-machine actuator 52 as shown in FIG. 10 is arranged on the side face of the movable member 7 in addition to the micro-machine actuator 51 of FIG. 11A, in which the movable member 7 is driven in a push-pull manner by the two actuators.

On a stump of the fixed arms of the micro-machine actuator 51, provided is an electrode 5a. On the fixed member 6 provided is an electrode 5b. On a stump of the fixed arms of the micro-machine actuator 52, provided is an electrode 5c. Control signals are supplied from an external driving circuit (not shown) to each of the actuators.

The micro-machine actuators 51 and 52 can position the movable member 7 along a circumference around the center of angular displacement on the fixed member 6. Each of the micro-machine actuators 51 and 52 can be defined as an actuator which is manufactured using the MEMS (Micro Electro-Mechanical Systems) technique, for example, a miniature actuator having dimensions of orders of micrometers to millimeters using magnetism, electric field, fluid, electrostriction, magnetostriction, thermal expansion or shape-memory material, etc.

In FIGS. 11A and 11B, the fixed member 6 for defining the center of angular displacement is preferably arranged off the optical path of the external resonator.

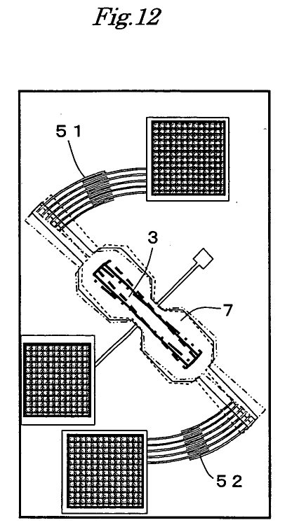

FIG. 12 is a plan view showing an example in which the center of angular displacement is arranged inside the optical path of the external resonator. The movable member 7 for supporting the tunable device 3 is so configured as to rotate around the center of the tunable device 3. The two micro-machine actuators 51 and 52 are arranged outside the movable member 7, respectively.

In such an arrangement, since a distance from the center of angular displacement to the action portion of the actuator is shortened, the moment (force * radius) for driving the movable member 7 becomes smaller in comparison to the arrangement in which the center of angular displacement is arranged off the optical path of the external resonator. Therefore, the two actuators 51 and 52 are indispensable. Furthermore, ensuring the moving range of the movable member 7 and the actuators 51 and 52 requires the longer optical path of the tunable unit 30.

Accordingly, as shown in FIGS. 11A and 11B, it is preferable that the fixed member 6 for defining the center of angular displacement is arranged off the optical path of the external resonator, thereby increasing the driving moment for the movable member 7 and shortening the length L of the external resonator.

In addition, the tunable unit 30 is assembled separately from the base 10, and then mounted on the base 10 at an assembly step for the tunable semiconductor laser apparatus. Consequently, a coarse adjustment of the tunable range can be carried out to enhance the mass-productivity of the apparatus.

### Embodiment 4

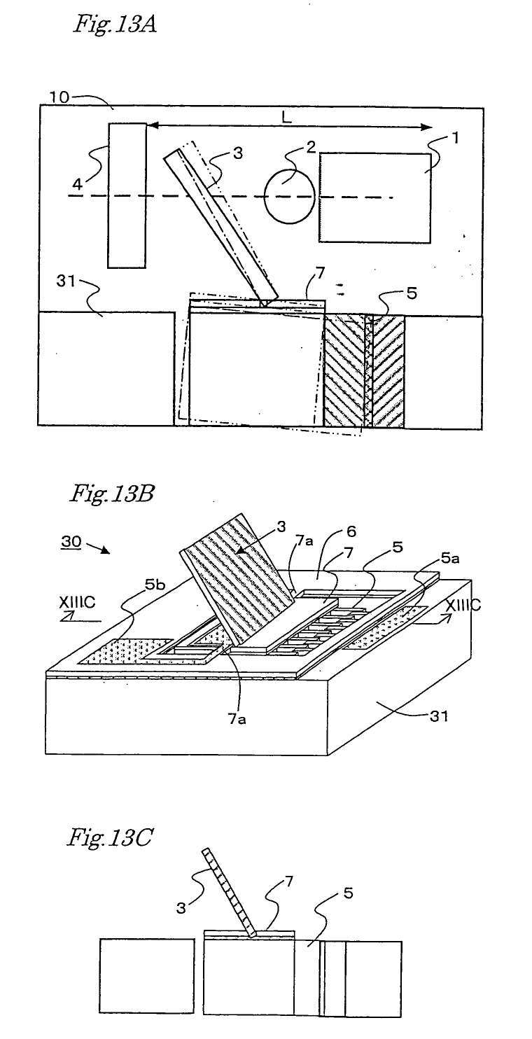

FIGS. 13A is a plan view showing the fourth embodiment according to the present invention, and FIG. 13B is a partial perspective view thereof, and FIG. 13C is a sectional view along the line C-C′ in FIG. 13B. A tunable semiconductor laser apparatus includes a semiconductor laser device 1, a light collecting device 2 for collecting light emitted from the semiconductor laser device 1, a reflecting device 4 for reflecting light from the light collecting device 2, a tunable device 3 having narrow band pass characteristics, and an angular displacement driving mechanism for angularly displacing the tunable device 3. In this embodiment, the tunable device 3 and the angular displacement driving mechanism for angularly displacing the tunable device 3 constitutes a tunable unit 30.

The semiconductor laser device 1, the light collecting device 2, the tunable device 3 and the reflecting device 4 are similar in configuration and operation to those of the first embodiment, hereinafter tautological description will be omitted.

In this embodiment, a unit base 31 of the tunable unit 30 is provided upright so that the rotary axis of the tunable device 3 is arranged in the normal direction of the base 10.

The angular displacement driving mechanism includes, as shown in FIG. 13B, a movable member 7 for supporting the tunable device 3, a fixed member 6 for defining the center of angular displacement of the movable member 7 through two beam members 7a, and a micro-machine actuator 5 for angularly displacing the movable member 7. The angular displacement driving mechanism for the tunable unit 30 is configured separately from the base 10.

The movable member 7 is suspended by the two beam members 7a which can be deformed with torsional elasticity. The rotary axis of the movable member 7 coincides with the longitudinal direction of the beam members 7a. The tunable device 3 is fixed with a predetermined tilt angle onto the upper surface of the movable member 7. The micro-machine actuator 5 is arranged on a side face of the movable member 7 to control the tilt angle of the the movable member 7.

The micro-machine actuator 5 can be defined as an actuator which is manufactured using the MEMS (Micro Electro-Mechanical Systems) technique, for example, a miniature actuator having dimensions of orders of micrometers to millimeters using magnetism, electric field, fluid, electrostriction, magnetostriction, thermal expansion or shape-memory material, etc. In this embodiment, the micro-machine actuator 5 is configured of the same comb actuator as described above. On the upper surface of the fixed member 6, provided are electrodes 5a and 5b which are electrically connected to the micro-machine actuator 5, to which a control signal is supplied from an external driving circuit (not shown).

As shown in FIG. 13A, the fixed member 6 for defining the center of angular displacement is preferably arranged off the optical path of the external resonator, thereby increasing the driving moment for the movable member 7 and shortening the length L of the external resonator.

In addition, the tunable unit 30 is assembled separately from the base 10, and then mounted on the base 10 at an assembly step for the tunable semiconductor laser apparatus. Consequently, a coarse adjustment of the tunable range can be carried out to enhance the mass-productivity of the apparatus.

### Embodiment 5

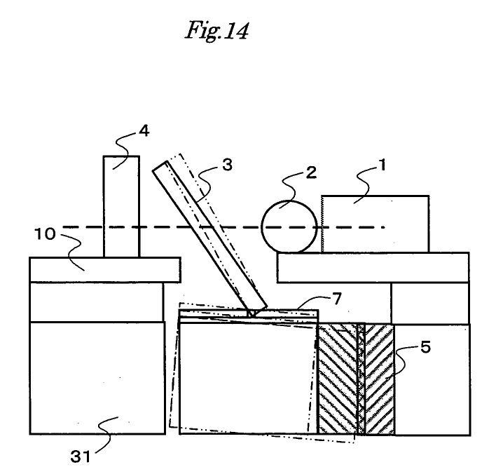

FIG. 14 is a side view showing the fifth embodiment according to the present invention. A tunable semiconductor laser apparatus includes a semiconductor laser device 1, a light collecting device 2 for collecting light emitted from the semiconductor laser device 1, a reflecting device 4 for reflecting light from the light collecting device 2, a tunable device 3 having narrow band pass characteristics, and an angular displacement driving mechanism for angularly displacing the tunable device 3. In this embodiment, the tunable device 3 and the angular displacement driving mechanism for angularly displacing the tunable device 3 constitutes a tunable unit 30.

The semiconductor laser device 1, the light collecting device 2, the tunable device 3 and the reflecting device 4 are similar in configuration and operation to those of the first embodiment, hereinafter tautological description will be omitted.

In this embodiment, a unit base 31 of the tunable unit 30 is provided in parallel onto the backside of the base 10 so that the rotary axis of the tunable device 3 is arranged in parallel to the base 10.

The angular displacement driving mechanism includes, as shown in FIG. 13B, a movable member 7 for supporting the tunable device 3, a fixed member 6 for defining the center of angular displacement of the movable member 7 through two beam members 7a, and a micro-machine actuator 5 for angularly displacing the movable member 7. The angular displacement driving mechanism for the tunable unit 30 is configured separately from the base 10.

The movable member 7 is suspended by the two beam members 7a which can be deformed with torsional elasticity. The rotary axis of the movable member 7 coincides with the longitudinal direction of the beam members 7a. The tunable device 3 is fixed with a predetermined tilt angle onto the upper surface of the movable member 7. The micro-machine actuator 5 is arranged on a side face of the movable member 7 to control the tilt angle of the movable member 7.

Also in this embodiment, the fixed member 6 for defining the center of angular displacement is preferably arranged off the optical path of the external resonator, thereby increasing the driving moment for the movable member 7 and shortening the length L of the external resonator.

In addition, the tunable unit 30 is assembled separately from the base 10, and then mounted on the base 10 at an assembly step for the tunable semiconductor laser apparatus. Consequently, a coarse adjustment of the tunable range can be carried out to enhance the mass-productivity of the apparatus.

Although the present invention has been fully described in connection with the preferred embodiments thereof and the accompanying drawings, it is to be noted that various changes and modifications are apparent to those skilled in the art. Such changes and modifications are to be understood as included within the scope of the present invention as defined by the appended claims unless they depart therefrom.

1. A tunable semiconductor laser apparatus with an external resonator comprising:
a semiconductor laser device having a first end face and a second end face, the second end face being coated with an antireflection film;
an optical device for collimating light emitted from the second end face;
a reflecting device for reflecting the light collimated by the optical device, the reflecting device and the first end face constituting an external resonator;
a tunable device located between the optical device and the reflecting device; and
a driving mechanism for angularly displacing the tunable device to control angle of incidence of light onto the tunable device, wherein the driving mechanism includes a micro-machine actuator.

2. The tunable semiconductor laser apparatus with an external resonator according to claim 1, wherein the driving mechanism includes:
a movable member for supporting the tunable device, the movable member being angularly disiplaceable; and
a fixed member for defining a center of angular displacement of the movable member, the fixed member being located off an optical axis of the external resonators, wherein the micro-machine actuator angularly displaces the movable member.

3. The tunable semiconductor laser apparatus with an external resonator according to claim 2, wherein the micro-machine actuator includes of a comb actuator.

4. The tunable semiconductor laser apparatus with an external resonator according to claim 1, further comprising:
a base member supporting the semiconductor laser device, the optical device, and the reflecting device; and
a tunable unit supporting the tunable device and the driving mechanism, the tunable unit being separate from the base member.

5. The tunable semiconductor laser apparatus with an external resonator according to claim 1, further comprising a reflecting angle adjustment mechanism for adjusting reflecting angle of the reflecting device.

6. The tunable semiconductor laser apparatus with an external resonator according to claim 5, wherein the reflecting angle adjustment mechanism includes:
a second movable member supporting the reflecting device; and
a pair of second micro-machine actuators for individually displacing respective locations of the movable member.

7. The tunable semiconductor laser apparatus with an external resonator according to claim 5, wherein the reflecting angle adjustment mechanism includes:
a second movable member supporting the reflecting device; and
a second micro-machine actuator for deforming the movable member by elastic bending.
